(19) United States
(12) Patent Application Publication
(10) Pub. No.: US 2023/0153778 A1
(43) Pub. Date: May 18, 2023

(54) SYSTEM AND METHOD FOR TRANSFERRING DATA DURING A PAYMENT PROCESS

(71) Applicant: MELIO LTD., TEL AVIV (IL)

(72) Inventors: ILAN ATIAS, KIRYAT ONO (IL); MATAN BAR, TEL AVIV (IL); TAL KIRSCHENBAUM, TEL AVIV (IL); EYAL YAVOR, TEL AVIV (IL); MICHAL KALLO GURA, TEL AVIV (IL)

(21) Appl. No.: 17/529,304

(22) Filed: Nov. 18, 2021

(51) Int. Cl. G06Q 20/14

(52) U.S. Cl. CPC G06Q 20/14

(57) ABSTRACT

A system including a computerized device, including a processing system of the computerized device including one or more processors, and a memory system including one or more computer-readable media, where the one or more computer-readable media contain instructions that, when executed by the processing system, cause the processing system to perform operations comprising identifying a specific purchasing entity buying at the selling business, outputting an invoice that is unique for the purchase, receiving a buyer's selection in which the buyer would like to send a payment request for the invoice to another person for the completion of the payment, and sending a command to an account or device associated by the another person to complete the purchase.

### FIELD

The invention generally relates to transferring data during a payment process.

### BACKGROUND

The transaction value for the Global Digital Payments Market was USD 5.44 trillion in 2020, and it is projected to be worth USD 11.29 trillion by 2026. Companies and persons may purchase goods or services via online pages that enable purchase of the goods/services. Many times, a person buys goods or services for a business but that person does not carry a credit card that can be used on behalf of the business. The person buying the goods or services may not be aware of the payment terms between the purchasing business and the selling business, or prefer to order the goods or services and have someone else within the purchasing business, such as the finance or procurement team, take care of the payment.

Many times, time is wasted both by the buyer that has to wait for approval of the purchase, or has to correct the payment terms after coming back to the office. In addition, this consumes time from the managers of the buyer, who has access to the payment terms, or is the one entitled to approve the purchase. This may require the owner of the purchasing business to go to the point of sale, again wasting precious time, or cause a delay in completion of the purchase.

### SUMMARY

In one aspect of the invention a system is provided including a computerized device including a processing system of the computerized device having one or more processors, and a memory system including one or more computer-readable media, where the one or more computer-readable media contain instructions that, when executed by the processing system, cause the processing system to perform operations including identifying a specific purchasing entity buying at the selling business, outputting an invoice that is unique for the purchase, receiving a buyer's selection in which the buyer would like to send a payment request for the invoice to another person for the completion of the payment, and sending a command to an account or device associated by the another person to complete the purchase.

In some cases, the instructions further include displaying a menu on a device operated by the another person, and receiving a desired payment method from the another person to pay for the invoice. In some cases, the instructions further include sending a payment request to an account or electronic device of the another person according to the desired payment method. In some cases, the instructions further include receiving from the user contact details of a another person. In some cases, the instructions further include extracting contact details of the another person from the memory system. In some cases, the invoice includes a unique Uniform Resource Locator (URL). In some cases, the instructions further include generating a web page unique to the purchase, where the web page includes details of the purchasing entity. In some cases, the web page unique to the purchase is accessible only based on inputting credentials.

### BRIEF DESCRIPTION OF THE DRAWINGS

The invention may be more clearly understood upon reading of the following detailed description of non-limiting exemplary embodiments thereof, with reference to the following drawings, in which:

FIG. 1 schematically shows a system for transferring information during a purchase process, according to exemplary embodiments of the invention;

FIG. 2 schematically shows a method for a selling business interacting with a buyer to determine whether the buyer is the payer, according to exemplary embodiments of the invention;

FIG. 3 schematically shows a method for completing payment by the payer of the purchasing entity, according to exemplary embodiments of the invention;

FIG. 4 schematically shows a method for transferring a payment request from the buyer's device to the payer's destination, according to exemplary embodiments of the invention.

The following detailed description of embodiments of the invention refers to the accompanying drawings referred to above. Dimensions of components and features shown in the figures are chosen for convenience or clarity of presentation and are not necessarily shown to scale. Wherever possible, the same reference numbers will be used throughout the drawings and the following description to refer to the same and like parts.

### DETAILED DESCRIPTION

Illustrative embodiments of the invention are described below. In the interest of clarity, not all features/components of an actual implementation are necessarily described.

For the purposes of this paper, and in order to enable clear understanding of the invention described herewith, the definitions and terms used in this paper shall have the meaning set forth beside them as well as the broadest meaning resulting from their context. However, it should be clearly understood, that the use of such meanings shall in no way serve to limit the scope of possible interpretation of the ideas, and the ideas and concepts provided herewith shall apply even if other terms and definitions are used.

The examples provided in this paper relate to the use of the invention for various applications. However, it is clearly stated that the use of the invention can apply to other types of applications and devices (such as speakers, smart phones), and for any device or application. In these cases, the features of the inventions described hereunder shall apply as well.

The invention, in embodiments thereof, provides a system and method for facilitating purchases. The system is coupled to the computerized systems of the selling business. The selling business may operate computerized systems, for example terminals located in physical points of sale, a database that stores purchases' history, purchasing rules, online servers that enable online purchases and the like. This way, the system has access to the purchases made in the selling business platforms, to payment terms between purchasing entity and the selling business, and to additional information provided by the selling business.

The purchasing entity may be any entity in which the buyer may not be the payer. The buyer is defined as a person who selects the goods or services to be purchased on behalf of the purchasing business. When the buyer is entitled to complete the purchase and wishes to complete the purchase, the buyer does so and completes the purchase. When the buyer is not entitled to complete the purchase, or in case the buyer is entitled to complete the purchase but prefers another person to complete the purchase, the invoice is sent to an account or device of a person entitled to approve purchases on behalf of the purchasing entity. The buyer may be a child wishing to buy goods, while the child's parent is the payer. In other cases, the buyer may be an employee, while the payer is the business owner, or a manager in the business. Hence, the purchasing entity may be a purchasing business or a household.

When a buyer purchases goods or services in the selling business platforms, the selling business identifies the purchasing entity. Then, the selling business outputs an invoice that is unique to the purchasing entity. The invoice may include a code, such as QR code, that opens a unique URL when scanned. The URL may be opened automatically when the user performs an action showing an intent to open the invoice, such as pressing, pointing or hovering over the invoice, or the invoice's name. The unique URL is unique to a specific invoice issued by the selling business. Then, the buyer selects in a user interface whether the buyer is the payer, or whether the buyer is not the payer. The user interface may be displayed on an electronic device operated by the buyer, such as a cellular phone, tablet, laptop, personal computer and the like. In case the buyer is the payer, the buyer completes the purchase. In case the buyer is not the payer, the invoice is sent to a destination associated with the purchasing entity. The destination may be an email address, a URL, an IP address, a phone number and the like. The destination may be inputted by the buyer, or stored in the memory of the system, or stored in the selling business' computerized platforms.

The processes and methods disclosed below may be performed by payment platforms, such as Melio payments, PayPal and others. The payment platforms may be online payments system. The payment platforms may store credit card details or other payment details inputted by the users. Then, the users purchase using a command, without re-inputting the payment details in every purchase.

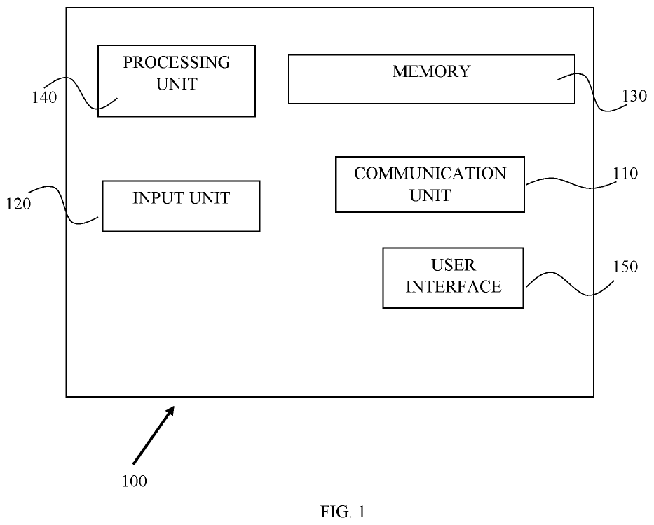

FIG. 1 schematically shows a system for transferring information during a purchase process, according to exemplary embodiments of the invention. The system may communicate with electronic devices of buyers, electronic devices of payers, electronic devices of selling businesses and additional devices.

The system includes a communication unit 110 for exchanging communication signals with other electronic devices, where exchanging includes at least one of sending and receiving signals. The communication unit 110 may enable the system to send invoices to buyers' devices, to payers' devices, to receive information from the devices communicating with the system, and the like. The communication unit 110 may use wireless communication techniques or wired communication.

The communication unit 110 may use any protocol or standard in any given frequency that can be used to conduct Radio and/or light and/or sound Wireless Communication, such as, but not limited to, wireless Information Technology, cellular communication (such as, but not limited to, GSM, GPRS, CDMA), Wireless Networks, WLAN computer communications, wireless networking standards (such as IEEE 802.11), wireless personal area networks (WPAN) and wireless mesh networks, and “Internet-of-Things”. It should be clearly stated that among such protocols, but not limited only to them, are Wi-Fi, Bluetooth, Low-Energy-Bluetooth (BLE), UWB, Wi-Max, ZigBee, Near-field Communication (NFC), RFID protocols or standards.

The system may also include an input unit 120 for receiving information or commands from users of devices communicating with the system. Such devices may be buyers' personal devices, payers' personal devices, such as cellular phones, laptops, tablets and the like. The input unit 120 may include a microphone used in the points of sale of the selling business, and may be used to receive voice commands from the buyer. The voice commands from the user may relate payment methods or to identifying the buyer before the selling business.

The system also includes a memory 130 for storing information. The memory 130 may store a set of instructions for performing the methods disclosed herein. The memory 130 may also store payment terms of purchasing entities, payment terms of selling businesses, preferences inputted by purchasing entities, credit card details, bank accounts, contact details associated with representatives of purchasing entities entitled to approve purchases, interfaces and formats associated with invoices issued by the selling businesses, commands or information to be sent to other devices, and the like.

The system includes a processor 140 that manages the processes and operations performed by the system's components. The processor 140 may include one or more processors, microprocessors, and any other processing device. The processor 140 is coupled to the communication unit 110 for sending commands to the communication unit 110 as to what content to send, when, and to which destination. The processor 140 is coupled to the memory 130 for executing a set of instructions stored in the memory 130.

The system may also include a user interface 150 for providing information to the user. The user interface may include a display or a speaker. The user interface 150 may be used by the system to display and/or provide information to the user or receive information from the user.

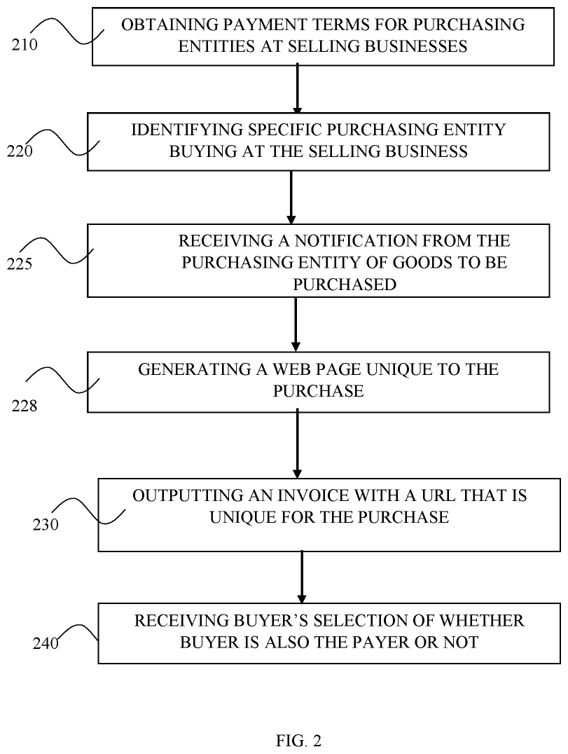

FIG. 2 schematically shows a method for a selling business interacting with a buyer to determine whether the buyer is the payer, according to exemplary embodiments of the invention.

Step 210 discloses obtaining payment terms and payment methods for purchasing entities at selling businesses. The payment terms may dictate the amount of time duration elapsing between the date of purchase and the date of payment. The payment method may be a wire transfer, cheques, credit card, debit card, a wire transfer, a bank transfer (ACH), and the details required to complete the payment, such as the bank account of the purchasing entity, name and/or contact details of a person authorized to pay or confirm the payment and the like. The payment terms and payment methods may be stored in a server accessed by the system, or by a server managed by the selling business.

Step 220 discloses identifying a specific purchasing entity buying at the selling business. The purchasing entity may be distinct from the person who performs the buying on behalf of the purchasing entity. For example, the purchasing entity may be a regular employee, and the person who performs the buying on behalf of the purchasing entity is a worker of the business. Identifying the specific purchasing entity may be performed by inputting credentials by the person acting on behalf of the specific purchasing entity, such as username, pin code, password, authentication key, credit card identifier, social security number and the like.

Step 225 discloses receiving a notification from the purchasing entity of goods to be purchased. The notification may be implemented as an email message, an SMS message, a notification from a mobile application and the like.

Step 228 discloses generating a web page unique to the purchase. Generation may be performed in response to identifying the purchasing entity and the goods to be purchased. The content of the web page may include details of the purchasing entity. The web page unique to the purchase may be accessible only based on inputting credentials, to prevent unauthorized persons or servers from reviewing purchasing history of the purchasing entity in the selling business. For example, enabling access to the web page unique to the purchase only to employees of the purchasing entity and employees of the specific point of sale of the selling business. Unique page is created once purchasing entity chooses to pay using the payment platform. The purchasing entity may then create an account or log in to the payment platform,

Step 230 discloses outputting an invoice with a URL that is unique for the purchase. In this context, the term “invoice” also includes a pro-forma invoice and/or an invoice preview. The invoice functions as a payment request in which the selling business requests the purchasing entity to pay for the goods to be purchased. The list of goods may appear on the invoice. The list of goods may be shown in the web page displayed when scanning the QR code unique to the purchase. The invoice is outputted when the person acting on behalf of the purchasing entity informs the selling business that he/she wish to complete the purchasing process in an online platform operated by the payment platform. The invoice may be outputted by sending a message or a file to an account or a device operated by the purchasing entity or by the person acting on behalf of the purchasing entity. Such device may be a mobile electronic device, such as a mobile phone, tablet computer, laptop, pager and the like. The account may be an email account, a social network account, an account in an instant messaging application, and the like.

Step 240 discloses receiving buyer's selection of whether the buyer would like to send the invoice payment request to another member of the purchasing entity organization for the completion of the payment. When receiving the invoice and the unique URL that is unique for the purchase, the buyer can select whether he/she would like to send the invoice to another member of the purchasing entity organization for the completion of the payment. The unique URL may be opened when the user presses on a link or scans a code, for example a QR code. The selection may be performed on the buyer's device within the web page, for example on a browser or a dedicated mobile software application used to facilitate payments. Such browser or application display a menu in which the user selects whether he/she would like to send the invoice to another member of the purchasing entity organization for the completion of the payment. If the buyer chooses to pay for the purchase, the buyer chooses the payment method, such as payment via bank transfer, credit or debit card. These payment details may be stored in the selling business platform or at the payment platform used by the selling business. Alternatively, the browser or application may then display a user interface for completing the purchase, in which the buyer inputs the necessary payment data needed to complete the purchase, such as payment credentials, or identifiers, [such as pin code, in case the payment means (credit card, bank account etc.) are already stored at the selling business' server.

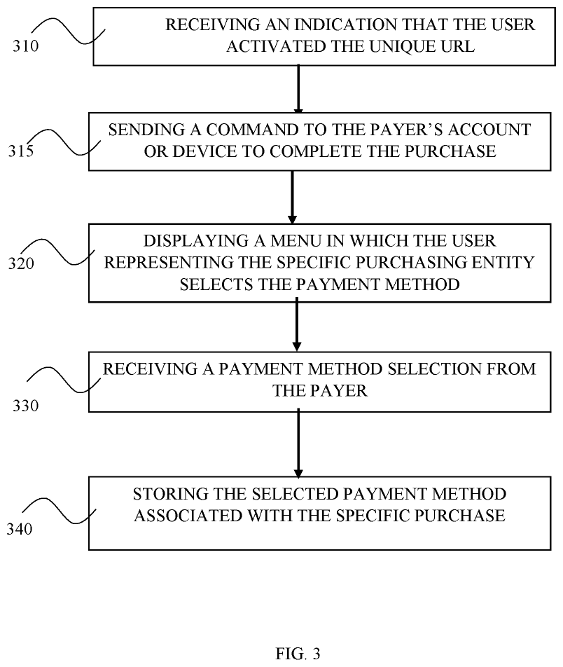

FIG. 3 schematically shows a method for completing payment by the payer of the purchasing entity, according to exemplary embodiments of the invention.

Step 310 discloses receiving an indication that the buyer activated the unique URL of the invoice. The indication may be received via a user interface of a device operated by the user acting on behalf of the purchasing entity. The user interface may be installed or embedded in a software application accessible to the selling business, such as a web page or a software application having a client side running on the device operated by the user. The indication may be sent to the selling business platforms over the internet, or over other communication networks, protocols or techniques selected by a person skilled in the art.

Step 315 discloses sending a command to the payer's account or device to complete the purchase. Once the payment platform receives an indication that the buyer chooses to share the invoice with another member of the purchasing entity, the payment platform sends a command to the entity who can complete the purchase, for example by emailing the invoice information and payment request to such the account or device of the person entitled to complete the purchase. The entity can be a person working for or otherwise representing the purchasing business. The command may be sent to the payer's account or device over the internet, or over other communication networks, protocols or techniques selected by a person skilled in the art. The details containing the payer's account or device may be inputted by the person acting on behalf of the purchasing entity as buyer. In some other cases, the details containing the payer's account or device may be stored in a memory address associated with the purchasing entity in a memory accessible to the payment platform used by the selling business.

Step 320 discloses displaying a menu in which the payer selects the payment method. The menu may be displayed on a browser, or a dedicated computer application used by the payer. The menu may be displayed on a device operated by the payer, or such as the payer's mobile phone or laptop. The menu may include data fields and titles elaborating which information is required to be inputted in each of the data fields.

Step 330 discloses receiving a payment method selection from the payer. Once the menu is displayed to the payer, the first step for completing the purchase may be to input the payment method desired by the purchasing entity. In some cases, the payment method is already stored on the payment platform used by the selling business and the payer only confirms that the purchasing entity wishes to use that payment method. The payment method may include a bank account, a credit card, a debit card, and other techniques, devices and processes desired by a person skilled in the art.

Step 340 discloses storing the selected payment method associated with the specific purchase. The selected payment method is stored in the payment platform used by the selling business or in a memory accessible to a software application that facilitates the payment process. The selected payment method and the payment details inputted and confirmed by the payer, are used to perform the payment.

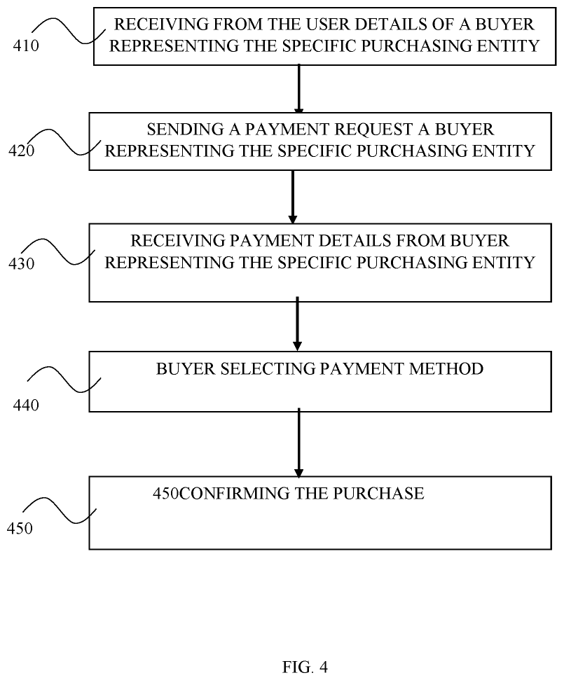

FIG. 4 schematically shows a method for transferring a payment request from the buyer's device to the payer's destination, according to exemplary embodiments of the invention.

Step 410 discloses receiving from the user contact details of a Payer, for example a person representing the specific purchasing business. The contact details may alternatively be stored in a memory accessible to the that facilitates the payment process. The contact details may be one or more of a person's name, a username, a device identifier, phone number, email address, identifier of an account in a payment service application, social network account, and the like.

Step 420 discloses sending a payment request to an account or electronic device of the payer. Sending may be performed over the internet, or over another network such as a cellular network, a local access network (LAN) and the like. The request may be sent to multiple destinations, such as to multiple email addresses, or to both an email address and to a phone number. The request may result in activating a computer software installed on a device operated by the payer. The computer software may then display a menu or another user interface on the device operated by the payer.

Step 430 discloses receiving payment details from the payer, such as bank account of the purchasing entity, virtual bank account of the purchasing entity, credit card details of the purchasing entity and the like. Step 440 discloses buyer selecting payment method, such as transfer from a bank account, credit card, debit card and the like. Step 450 discloses confirming the purchase. After the buyer completes the process of selecting payment method and adding the relevant payment details, the buyer will confirm and schedule the payment. At this stage, the user interface provided to the buyer may display purchase information, such as the payment's amount, name of vendor being paid, payment details and estimated deduction data of the payment (based on the invoice information).

While the disclosure has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings without departing from the essential scope thereof. Therefore, it is intended that the invention not be limited to the particular embodiments disclosed herein.

1. A system comprising a computerized device, comprising:
a processing system of the computerized device comprising one or more processors; and
a memory system comprising one or more computer-readable media, wherein the one or more computer-readable media contain instructions that, when executed by the processing system, cause the processing system to perform operations comprising:
identifying a purchasing entity performing a purchase at a selling business via an account used by a buyer, wherein the buyer cannot approve payment for the purchase,
generating a web page comprising an invoice identifying the purchase, the web page associated with a unique code which enables access to the web page when used,
receiving a buyer's selection provided after the buyer uses the unique code to access the web page, the selection indicating that a payment request for the invoice is to be sent to a second person to approve payment for the purchase, wherein the second person is stored in the memory system as being entitled to approve purchases on behalf of the purchasing entity,
sending a command to an account or device associated by the second person to complete the purchase,
receiving confirmation to pay for the purchase from the second person and payment details, and
completing the payment using payment details input and confirmed by the second person.

2. The device of claim 1, wherein the instructions further comprise displaying a menu on a device operated by the second person, and receiving a desired payment method from the second person to pay for the invoice.

3. The device of claim 2, wherein the instructions further comprising sending a payment request to an account or electronic device of the second person according to the desired payment method.

4. The device of claim 1, wherein the instructions further comprising receiving from the user contact details of the second person.

5. The device of claim 1, wherein the instructions further comprising extracting contact details of the second person from the memory system.

6. The device of claim 1, wherein the invoice comprises a unique Uniform Resource Locator (URL).

7. The device of claim 1, wherein the instructions further comprising generating a web page unique to the purchase, wherein the web page comprises details of the purchasing entity.

8. The device of claim 7, wherein the web page unique to the purchase is accessible only based on inputting credentials.

9. The device of claim 1, wherein the second person is working for the purchasing entity.

10. (canceled)
